(19) United States
(12) Patent Application Publication
(10) Pub. No.: US 2015/0170229 A1
(43) Pub. Date: Jun. 18, 2015

(54) Systems and Methods for Summarizing a Guidebook Result

(71) Applicant: GOOGLE INC., (US)

(72) Inventors: Holger-Frederik Robert Flier, Zurich (CH); Albert Graells, Zurich (CH)

(73) Assignee: GOOGLE INC., MOUNTAIN VIEW, CA (US)

(21) Appl. No.: 13/894,040

(22) Filed: May 14, 2013

(51) Int. Cl. G06Q 30/02

(52) U.S. Cl. CPC G06Q 30/0283

(57) ABSTRACT

Systems and methods for summarizing a guidebook result are provided. An exemplary system includes a transit trip identification module, a cost function generation module, a service window identification module, a daytime interval conversion module, and a guidebook summarization module. An exemplary method includes identifying a plurality of service windows comprising intervals of time over which the available transit trips satisfy a quality criterion. The exemplary method also includes selecting as a guidebook summary a set of days of the week and a continuous interval of time which include only portions of service windows, such that a total number of hours included in the guidebook summary is maximized

### FIELD

The present disclosure relates generally to providing navigational instructions. In particular, the present disclosure relates to systems and methods for summarizing available transit trips as recommended by a guidebook result.

### BACKGROUND

Many services exist for planning a route using a transit system. Typically, a user inputs a departure and/or arrival time as well as origin and destination locations to the transit planning service. The transit planning service can then use the user inputs and transit schedules to suggest one or more transit options that can get the user from the origin to the destination at the prescribed departure and/or arrival time. More particularly, the transit planning services can plan specific transit trips that involve multiple modes of transportation, including railway transportation, buses, ferries, etc.

In some situations, however, a user may not be interested in obtaining a particular transit trip for a particular departure and/or arrival time. Rather, the user is generally interested in a recommendation of times at which one or more transit routes provide typically good trips between the origin and destination over the course of a day, week, or other period. These “guidebook” results may be analogous to a typical or usual route one might take from the origin to the destination, such as a route that one might find in a guidebook or a tourist brochure.

However, many different transit trips can be available over the course of the day or week. Further, such transit trips can run along different transit routes or be provided by different transportation providers. Thus, it can be difficult to determine the appropriate times at which transit trips from an origin and destination are suitable for recommendation in accordance with a guidebook result. Further, summarizing the guidebook result into a visual or textual format can be challenging, as a trade-off between the length of the summary and the accuracy and usefulness of the summary must be found.

### SUMMARY

Aspects and advantages of the invention will be set forth in part in the following description, or may be obvious from the description, or may be learned through practice of the invention.

One aspect of the present disclosure is directed to a computer-implemented method for summarizing available transit trips. The method includes generating, based on a plurality of transit trips from an origin to a destination, a cost function specifying a trip cost as a function of time over a time period. The method also includes identifying a plurality of service windows comprising intervals of time over which the trip cost specified by the cost function satisfies a quality criterion. The method includes translating the plurality of service windows into a plurality of daytime intervals. Each daytime interval can be associated with a day of the week and can have a duration of twenty-four hours or less. The method also includes identifying a guidebook summary that includes only portions of daytime intervals and maximizes a total number of hours included in such guidebook summary. The guidebook summary can describe an interval of time and a set of days of the week.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an overview of an exemplary system for providing a guidebook summary according to an exemplary embodiment of the present disclosure;

FIG. 2 depicts a flow diagram of an exemplary method for providing a guidebook summary according to an exemplary embodiment of the present disclosure;

FIG. 3 depicts an exemplary cost function according to an exemplary embodiment of the present disclosure;

FIG. 4 depicts an exemplary cost function according to an exemplary embodiment of the present disclosure;

FIG. 5 depicts an exemplary cost function according to an exemplary embodiment of the present disclosure;

FIG. 6 depicts exemplary service windows identified with respect to an exemplary cost function according to an exemplary embodiment of the present disclosure;

FIG. 7 depicts an exemplary service window and exemplary daytime intervals according to an exemplary embodiment of the present disclosure;

FIG. 8 depicts a plurality of exemplary daytime intervals according to an exemplary embodiment of the present disclosure;

FIG. 9 depicts an exemplary guidebook summary according to an exemplary embodiment of the present disclosure; and

FIG. 10 depicts an exemplary system for providing a guidebook summary according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a method for summarizing available transit trips, such as transit trips along one or more transit routes recommended by a guidebook result. In particular, a guidebook summary can be determined which provides a summary of the most relevant or highest quality operating hours of the one or more transit routes recommended by a guidebook result. The guidebook summary can be depicted visually or represented by a short text string.

A cost function can be generated based on the available transit trips from an origin to a destination. The cost function can provide a trip cost as a function of time over a time period. As an example, the cost function can be a piecewise linear function including a plurality of linear trip segments. Each linear trip segment can model the trip cost, including waiting time, of one of the available transit trips as a function of time. As another example, the cost function can specify a total time until arrival at the destination for any point in time over the time period.

A plurality of service windows can be identified based on the cost function. For example, each service window can be a maximal interval of time over which the trip cost provided by the cost function satisfies one or more quality criteria. As an example, the plurality of service windows can be intervals of time over which the trip cost provided by the cost function is less than or equal to a threshold value. For example, the threshold value can be a median value of a plurality of local maximums exhibited by the cost function. As another example, the threshold value can be determined with respect to a global minimum value exhibited by the cost function.

The plurality of service windows can be translated into a plurality of local daytime intervals. Each daytime interval can be associated with a day of the week and span less than twenty-four hours (e.g. Monday, “9:00-20:00”). As an example, the plurality of service windows can be translated into the plurality of daytime intervals by parsing any service window that has a duration greater than twenty-four hours into two or more service windows. Then, each service window can be associated with the day of the week on which such service window begins, such that a plurality of daytime intervals are created.

A guidebook summary can be computed based on the plurality of daytime intervals and can describe a set of days of the week and a continuous time interval (e.g. Monday, Wednesday, Friday, “9:00-18:00”). In particular, the guidebook summary can computed in such a way that it maximizes the probability that the guidebook summary covers a randomly selected time on a randomly selected day of the week.

As an example, identifying the guidebook summary can include computing, for each instance in which portions of two or more of the plurality of daytime intervals share overlapping times independent of their days of the week, a total number of hours included in such portions. The overlapping portions that include the largest total number of hours can be selected as the guidebook summary.

As another example, identifying the guidebook summary can include traversing a graph describing the plurality of daytime intervals. The graph can have each day of the week as a unit on the y-axis and units of time of the x-axis. For each of a plurality of x-axis intervals in which portions of two or more daytime intervals continuously overlap with respect to the x-axis, a total area covered by such portions over such x-axis interval can be computed. The x-axis interval associated with the largest total area and the days of the week associated with the portions of the two or more daytime intervals that continuously overlap over such x-axis interval can be selected as the guidebook summary.

The guidebook summary can be provided to a user such that the user is informed of times at which typically good trips are available from the origin to the destination. For example, the guidebook summary can be represented in a short text string such as, for example, “M-F, 9 am-9 pm”.

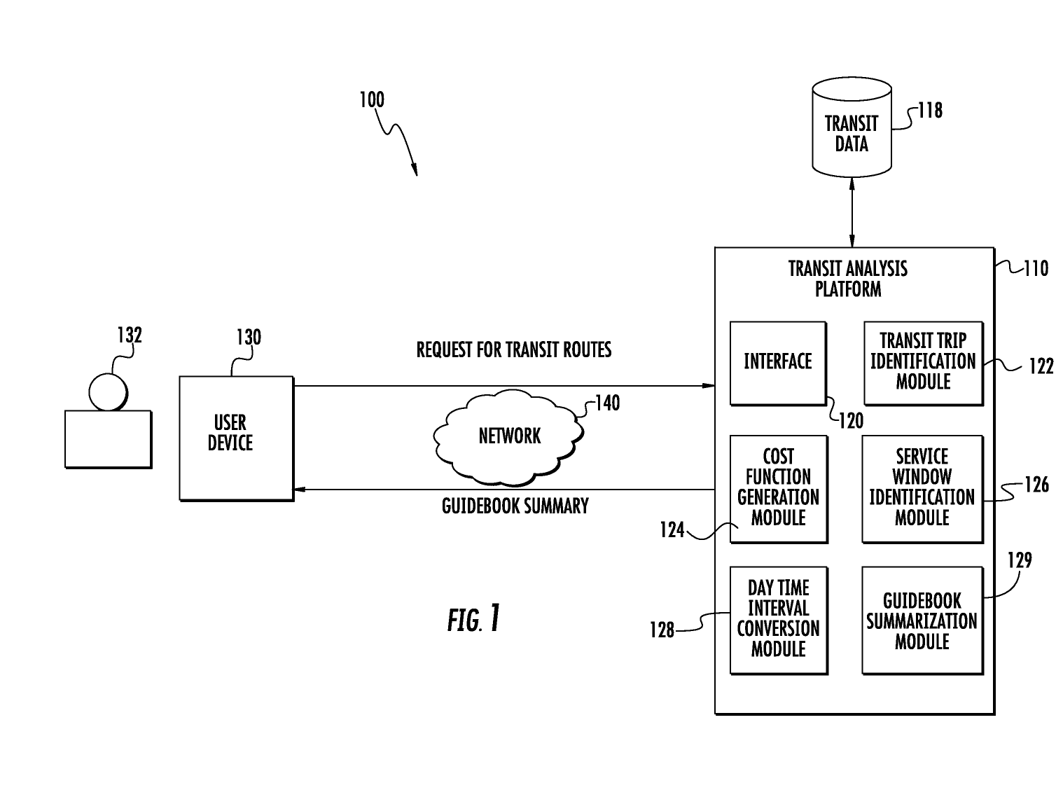

With reference now to the FIGS., exemplary embodiments of the present disclosure will now be discussed in detail. FIG. 1 depicts an overview of an exemplary system 100 for providing a guidebook summary according to an exemplary embodiment of the present disclosure. The system 100 can include a transit analysis platform 110 in communication with a computing device 130 over a network 140. The transit analysis platform 110 can be hosted by any suitable computing device, such as a web server. The computing device 130 can be any suitable computing device, such as a laptop, desktop, smartphone, tablet, mobile device, or other computing device.

A user 132 can input a request for one or more transit routes from an origin to a destination into the computing device 130 using a suitable user interface, such as a browser or other interface. The computing device 130 can send the request for transit routing information to the transit analysis platform 110. In particular, the user request can be a request for a “guidebook” result and therefore seek a general recommendation of times at which one or more transit routes provide typically good transportation from the origin to the destination. As a result, the request may not specify a specific departure time or a specific arrival time. Other suitable requests for transit information can be provided without deviating from the scope of the present disclosure. For instance, a request for transit routes between the origin and destination with specified arrival and/or departure times can be provided.

The transit analysis platform 110 can receive the request from the computing device 130. For example, the transit analysis platform 110 can include a suitable interface 120 for connecting to the network 140 and receiving the request. In response to the request, the transit analysis platform 110 can access transit data 118. The transit data 118 can include information associated with a transit system, such as transit schedules, departure times, arrival times, stops, costs, walking distance, transfers, and other information associated with the transit system.

In response to the request, transit analysis platform 110 can implement a transit trip identification module 122 to identify a plurality of transit trips providing transportation between the origin and the destination. In particular, transit trip identification module 122 can access and analyze transit data 118 in order to identify the plurality of available transit trips. For example, transit trip identification module can be configured to perform one or more search algorithms with respect to transit graph data constructed based in part on transit data 118.

Transit analysis platform 110 can further implement a cost function generation module 124 to generate a cost function specifying a trip cost as a function of time over a time period. In particular, cost function generation module 124 can generate the cost function based on the plurality of transit trips identified by transit trip identification module 122.

A service window identification module 126 can be implemented by transit analysis platform 110 to identify a plurality of service windows based on the cost function generated by cost function generation module 124. In particular, the plurality of service windows identified by service window identification module 126 can be intervals of time over which the trip cost specified by the cost function satisfies a quality criterion.

Transit analysis platform 110 can further implement a daytime interval conversion module 128 to convert the plurality of service windows into a plurality of daytime intervals. As an example, daytime interval conversion module 128 can be configured to parse any service window initially exceeding twenty-four hours in length into two or more service windows. Daytime interval conversion module 128 can be further configured to associate each of the plurality of service windows with the day of the week in which such service window begins. In such fashion, the plurality of daytime intervals can be generated.

A guidebook summarization module 129 can be implemented by transit analysis platform 110 to compute a guidebook summary. In particular, the guidebook summary can be a set of days of the week and a continuous time interval that include only portions of one or more daytime intervals. As an example, guidebook summarization module 129 can compute the guidebook summary in such a way that it maximizes the probability that the guidebook summary covers a randomly selected time of a randomly selected day of the week.

After guidebook summarization module 129 computes the guidebook summary, the transit routing platform can send the guidebook summary to the user device 130, for instance, over the network 140. The user device 130 can then display the guidebook summary to the user 132 through a suitable user interface.

As an example, the guidebook summary can be displayed on the user device 130 in association with one or more recommended transit routes, the next departure times of transit trips associated with the recommended transit routes, a frequency associated with the recommended transit routes, and/or any other suitable information. In one implementation, the guidebook summary is presented in association with a geographic information system on a user device 130 that includes a positioning system such as GPS so that the user 132 can be provided with continuing navigational instruction until user 132 reaches the destination.

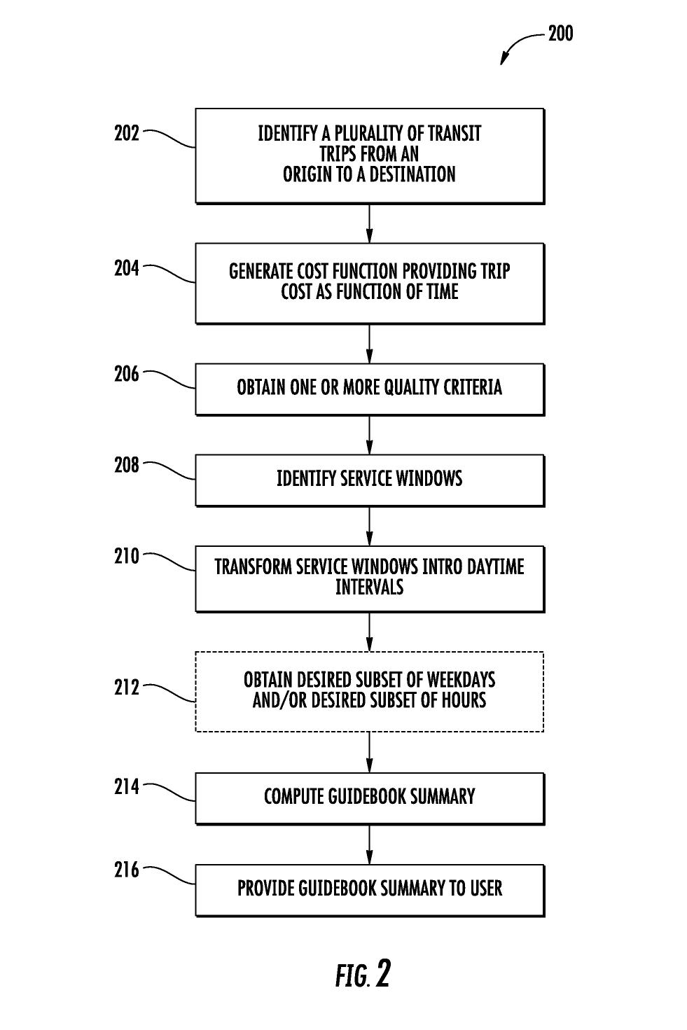

FIG. 2 depicts a flow diagram of an exemplary method (200) for providing a guidebook summary according to an exemplary embodiment of the present disclosure. The method (200) can be implemented using any computing device or system, such as the transit analysis platform 110 of FIG. 1 or the system 1000 illustrated in FIG. 10. In addition, FIG. 2 depicts steps performed in a particular order for purposes of illustration and discussion. Those of ordinary skill in the art, using the disclosures provided herein, will understand that the various steps of any of the methods disclosed herein can be omitted, adapted, and/or rearranged in various ways.

At (202), the method includes identifying a plurality of transit trips between an origin and a destination. The plurality of time independent transit routes can be identified using transit trip searching techniques, such as Djikstra search techniques used to search a transit graph modeling a transit network between the origin and the destination. Other suitable techniques for identifying the plurality of transit trips can be used without deviating from the scope of the present disclosure.

As used herein, a transit route is a fixed set of transit paths between an origin and a destination and can include multiple modes of transportation. An example transit route can be a combination of one or more portions of transit lines, such as bus lines, rail lines, walking paths, etc. that allow an individual to reach the destination.

As used herein, a transit trip is a specific instance of transportation over the transit route and is associated with a particular departure time and a particular arrival time. A plurality of transit trips can be associated with each transit route and can have different departure and arrival times. The departure and arrival times can be estimated times or can be times determined or identified from data associated with the transit network, such as transit time tables.

The plurality of transit trips can be specific instances of available transit transportation along one or more transit routes. In particular, the plurality of transit trips identified at (202) can include trips along one or more transit routes that are recommended to a user as a guidebook result.

Each transit trip can have a trip duration. The trip duration can be determined using time tables stored associated with the transit trips or can be calculated based on the arrival times and departure times associated with the transit trips. In particular, the duration of a particular transit trip can be equal to the difference between the arrival time and the departure time. If a trip over the time independent transit route involves multiple modes of transportation, the trip duration can based on the departure times and arrival times of each mode of transportation within the trip. The trip duration can also take into account average durations, such as time to transfer or walk between adjacent stations.

At (204) a cost function can be generated that specifies a trip cost as a function of time over a time period. For example, the cost function can be a function ƒ(t) that specifies a trip duration to reach the destination for every time t. The cost function can be a piecewise linear function that includes a plurality of linear trip segments. Each linear trip segment models the trip cost, including waiting time, of one of the plurality of transit trips over the time independent transit route as a function of time.

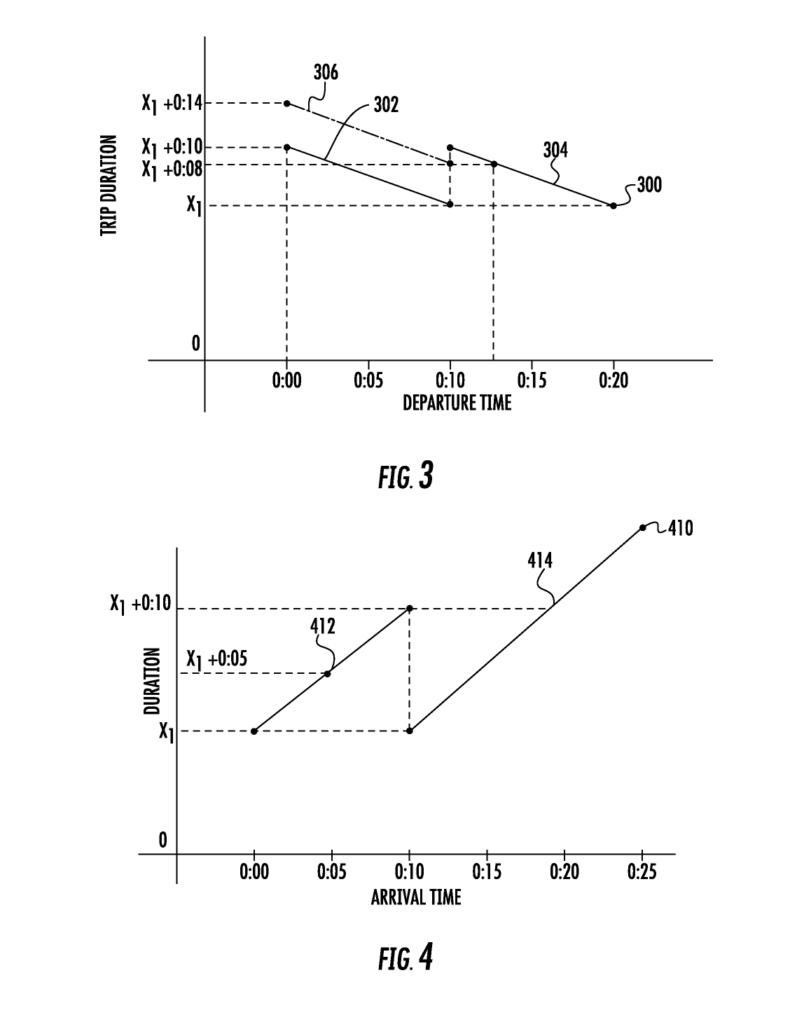

FIG. 3 depicts an exemplary cost function 300 generated for one or more transit routes from an origin to a destination over a time interval from 0:00 to 0:20. The cost function 300 specifies a trip duration for one or more transit routes between the origin and the destination as a function of departure time. FIG. 3 depicts three linear trip segments 302, 304, and 306. While the present example will be discussed with reference to three trip segments for purposes of illustration and discussion, those of ordinary skill in the art, using the disclosures provided herein, will understand that the cost function can include many linear trip segments.

Further, the time interval of 0:00 to 0:20 provided in FIG. 3 is exemplary in nature. More particular, according to an aspect of the present disclosure, the cost function generated at (204) can specify a trip cost over an entire time period P. Time period P can equal one day, one week, three weeks, one month or any other suitable period. Further, trip costs can be averaged or compared across successive periods, such as averaging trip costs across three weeks of data.

Returning to FIG. 3, the linear trip segments 302, 304, and 306 each model a duration, including waiting time, of one of the plurality of trips over one of the recommended transit routes as a function of departure time. For instance, linear trip segment 302 can be associated with a transit trip that departs at time 0:10 and has a duration of x₁. The cost function 300 specifies a duration of x₁ for a user that begins travel over the time independent transit route at time 0:10. The linear trip segment 302 has a slope of −1 to model waiting time. For instance, if a user begins travel at time 0:00, the user will have to wait 0:10 until the transit trip associated with trip segment 302 departs. Thus, the cost function 300 specifies a trip duration of x₁+0:10 at time 0:00.

Trip segment 306 models trip duration, including waiting time, in a similar fashion. Linear trip segment 306 can be associated with a transit trip that departs at time 0:10 and has a duration of x₁+0:08. For example, linear trip segment 306 can be represent a transit trip available over a second, different transit route than the first transit route taken by the transit trip modeled by trip segment 302. However, linear trip segment 306 will not be included in cost function 300 because the transit trip modeled by trip segment 302 is always superior to the transit trip modeled by trip segment 306. In other words, because linear trip segment 306 does not provide a minimum trip duration at any point in time, it will not be included in cost function 300.

Trip segment 304 models trip duration, including waiting time, in a similar fashion. Linear trip segment 304 can be associated with a transit trip that departs at time 0:20 and has a duration of x₁. The cost function 300 specifies a duration of x₁ for a user that begins travel over the time independent transit route at time 0:20. The linear trip segment 304 has a slope of −1 to model waiting time. For instance, if a user begins travel at time 0:12, the user will have missed the opportunity to travel on the transit trip associated with the linear trip segment 302. The user will have to wait 0:08 until the transit trip associated with trip segment 404 departs. Thus, the cost function 300 specifies a trip duration of x₁+0:08 at time 0:12. Therefore, cost function 300 includes linear trip segments 302 and 304, but not linear trip segment 306.

FIG. 4 depicts another exemplary cost function 410 generated for one or more transit routes over a time interval from 0:00 to 0:25. The cost function 410 specifies a minimum trip duration for the recommended transit routes as a function of arrival time. The cost function 410 includes two linear trip segments 412 and 414. The linear trip segments 412 and 414 model a duration, including waiting time of one of the plurality of trips over the time independent transit route as a function of arrival time.

For example, linear trip segment 412 can be associated with a transit trip that arrives at time 0:00 and has a duration of x₁. The trip function 410 specifies a duration of x₁ for a user that wishes to arrive at time 0:00. The linear trip segment 412 has a slope of 1 to model waiting time. For instance, if a user wishes to end travel at 0:05, the user will have to wait 0:05 after transit trip associated with trip segment 412 arrives. Thus, the cost function 410 specifies a trip duration of x₁+0:05 at time 0:05.

Trip segment 424 models trip duration, including waiting time, in a similar fashion. Linear trip segment 424 can be associated with a transit trip that arrives at time 0:10 and has a duration of x₁. The trip function 410 specifies a minimum duration of x₁ for a user that desires to arrive at time 0:00. The linear trip segment 414 has a slope of 1 to model waiting time. For instance, if a user wishes to end travel at time 0:20, the user will have to wait 0:10 after the transit trip associated with trip segment 414 arrives. Thus, the cost function 410 specifies a trip duration of x₁+0:10 at time 0:20.

In certain cases, a transit route can be associated with a frequency based trip. The exact departure and arrival times for the frequency based trips may be unknown. However, it may be known that over a given time interval, a particular transit trip runs every Y minutes and has a duration of x₂. Based on this information, it is known that the frequency based trip will have a maximum duration of x₂+Y. A linear trip segment can model this frequency based trip as a linear segment having a slope of 0 and a constant value equal to x₂+Y.

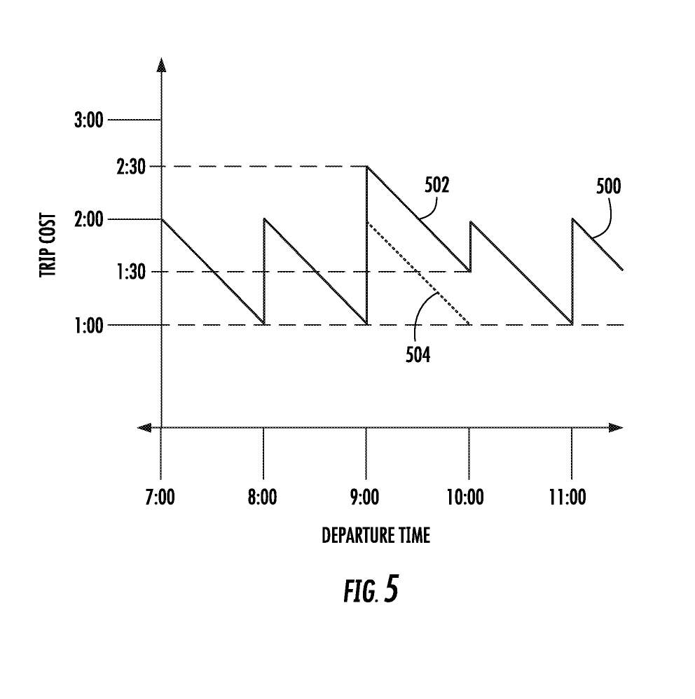

The exemplary cost functions of FIGS. 3 and 4 each specify a trip cost based on trip duration as a function of time. In other embodiments, the trip costs specified by the cost function can include other parameters. For example, FIG. 5 depicts another exemplary cost function 500 generated for one or more transit routes over a time interval from 7:00 to 11:00. As shown in FIG. 5, a plurality of linear trip segments can model a plurality of transit trips that depart from an origin for a destination at a frequency of once per hour. Each transit trip can have a duration of one hour.

However, the trip cost specified by cost function 500 can be include other parameters in addition to trip duration, including, but not limited to, required walking, transfers, fares, vehicle providers, vehicle types, or other suitable parameters. For example, a penalty (e.g. a 5 minute or other suitable penalty) can be added to the trip duration specified by the cost function if the transit route requires a transfer. Another penalty (e.g. a 10 minute or other suitable penalty) can be added to the trip cost specified by the cost function if the transit route requires walking. The penalty can be based on walking distance or walking time.

The penalty can be incorporated into one or more individual trip segments of the cost function or can be incorporated across the entire cost function. As an example, consider that the particular transit trip departing at 10:00 has an added fare of $30, which is not required by the other transit trips. Due to such added fare, a linear trip segment 502 that models the transit trip departing at 10:00 can be penalized. In particular, as shown in FIG. 4, a 30 minute penalty has been added to linear trip segment 502. Therefore, instead of being modeled based solely on duration, as would be shown by linear segment 504, linear trip segment 502 includes the added time penalty. In this manner, different penalties can be associated with different transit trips in the determination of the cost function for the recommended transit routes. It will be appreciated that the one-to-one correlation between fare value and added time penalty provided above is exemplary in nature and can be varied according to any suitable design scheme. Further, trip cost can be specified in units other than time.

Returning to FIG. 2, at (206) one or more quality criteria can be obtained. In particular, the cost function can be analyzed at (208) based on one or more quality criteria and such quality criteria can be obtained at (206). For example, the quality criteria can be a maximum duration (i.e. travel time or waiting time) that is acceptable to qualify as a typically good trip and therefore be recommended in association with a guidebook result. The quality criteria can be computed at (206), saved in memory and accessed at (206), or can be an aspect of a user-inputted request received or analyzed at (206). The quality criteria will be discussed further with respect to step (208).

At (208) a plurality of service windows can be identified. Each service window can consist of a time interval over which the trip cost specified by the cost function generated at (204) satisfies the one or more quality criteria obtained at (206).

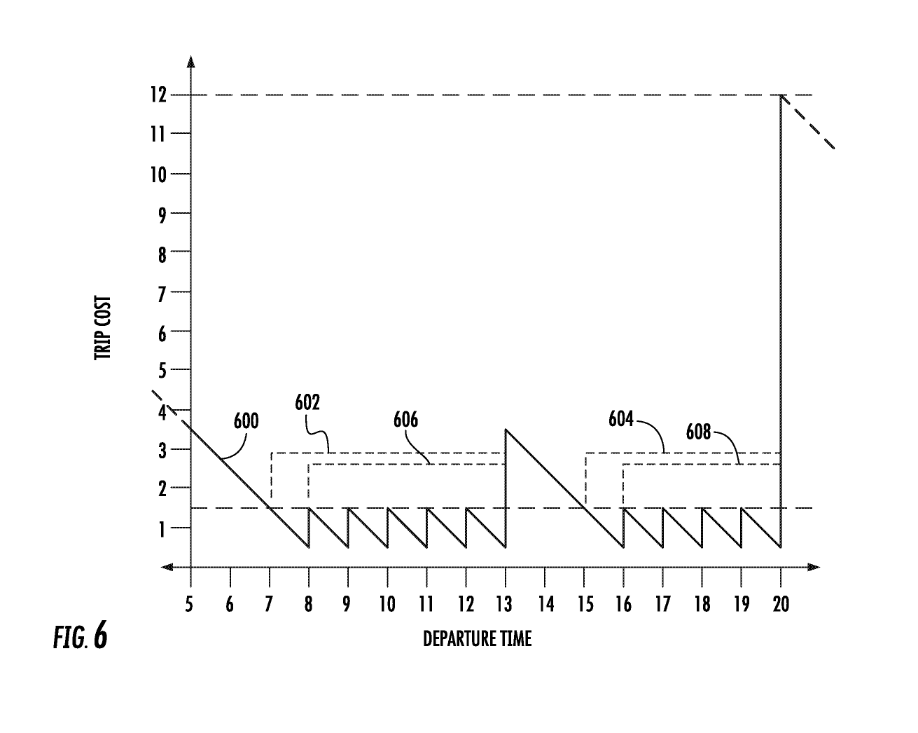

For example, FIG. 6 depicts exemplary service windows 602-608 identified with respect to an exemplary cost function 600 according to an exemplary embodiment of the present disclosure. The cost function 600 specifies a trip cost for one or more transit routes between the origin and the destination as a function of departure time over the time interval 5:00 to 20:00. Service windows 602-608 identify intervals of time over which the trip cost specified by cost function 600 satisfies one or more quality criterion.

As an example, the quality criterion can be a threshold value such that the trip cost specified by cost function 600 satisfies the quality criterion when it is less than or equal to the threshold value. In one implementation, the quality criterion is equal to a median value of a plurality of local maximums exhibited by cost function 600. In particular, the local maximums can correspond to worst-case scenarios, in which a passenger arrives at the origin station just following the departure of an available transit trip.

For example, in FIG. 6, the local maximums occur instantaneously after departure times 8:00, 9:00, 10:00, 11:00, 12:00, 13:00, 16:00, 17:00, 18:00, 19:00, and 20:00. The median of such local maximums is a trip cost of 1.5. Therefore, the quality criterion can equal 1.5. It will be appreciated that quality criterion can be determined on a day-by-day basis as shown in FIG. 6 or can applied uniformly across an entire period P, such as a week's worth of trip costs.

The service windows identified at (208) can consist of the maximal intervals over which the trip cost specified by cost function 600 satisfies the quality criterion. In the above instance in which the quality criterion equals a threshold value of 1.5, the service windows can be maximal intervals over which the trip cost is less than or equal to 1.5, such as service window 602 [7:00-13:00] and service window 604 [15:00-20:00].

The quality criteria can include other parameters in addition to a threshold value. For example, in one implementation, service windows are constrained to begin at a local minimum of the cost function. In particular, the local minimum can correspond to a departure of a transit trip from the origin. Therefore, in the instance in which the quality criterion includes a threshold value of 1.5 and requires that service windows begin at a local minimum, the service windows can include service window 606 [8:00-13:00] and service window 608 [16:00-20:00].

The quality criteria can be computed or determined in many different ways or forms. For example, the quality criteria can have a threshold value equal to a global minimum (i.e. best-case scenario) multiplied by 1.2. As another example, an acceptable waiting time, such as 30 minutes can be added to the global minimum to obtain the threshold value.

Any other suitable method for determining or obtaining a quality criterion can be used to satisfy the present disclosure. In particular, the quality criterion can be any criterion that serves to identify service windows over which available transit trips are of sufficient quality to recommend to the user.

Returning to FIG. 2, at (210) the service windows identified at (208) can be transformed into daytime intervals. In particular, each daytime interval can have a duration of twenty-four hours or less in length and can be associated with the day of the week upon which it begins.

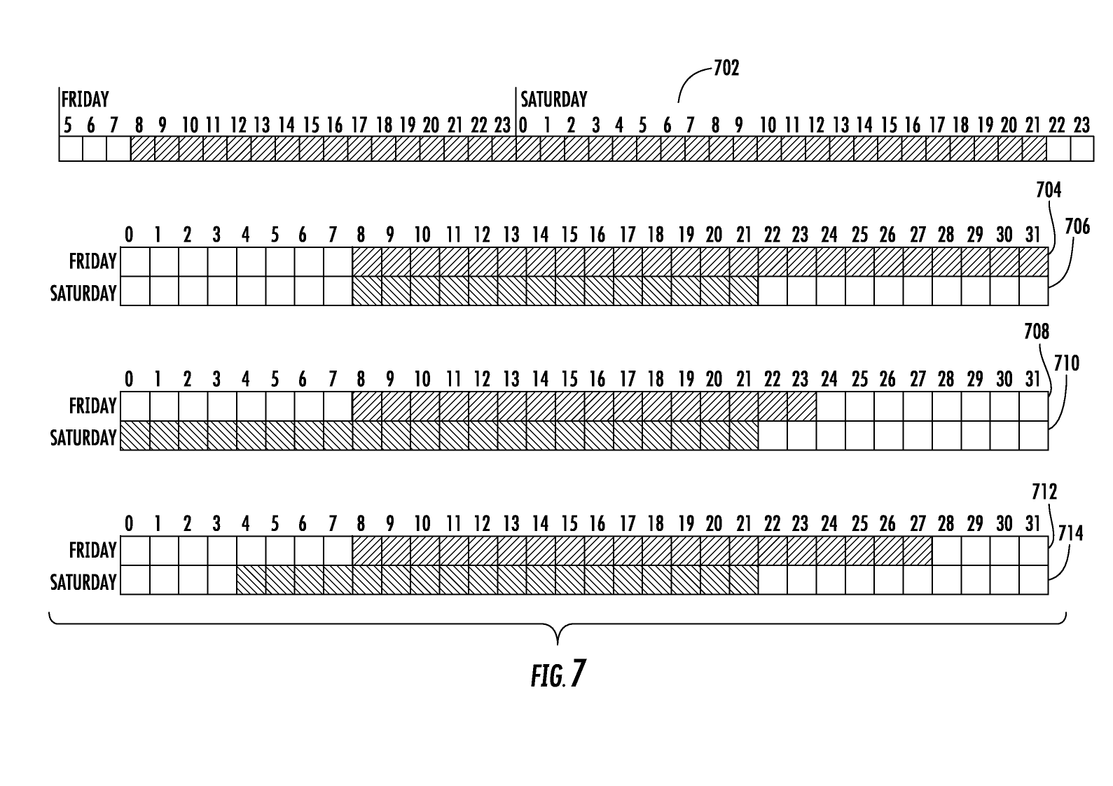

For example, FIG. 7 depicts an exemplary service window 702 and exemplary daytime intervals 704-714 according to an exemplary embodiment of the present disclosure. Service window 702 runs from Friday at 8:00 to Saturday at 22:00. Thus, transit trips available during service window 702 satisfied the quality criterion over such interval of time. While service window 702 is shown as having been discretized into units one hour in length, such depiction is for the purposes of explanation only. For example, service window 702 can be an interval of time described in units of minutes or less (e.g. [8:38-16:19]).

According to an aspect of the present disclosure, service window 702 can be translated or converted into two or more daytime intervals, such as daytime intervals 704 and 706, 708 and 710, or 712 and 714. In particular, service window 702 can be parsed in order to be converted into such daytime intervals.

In one implementation, service window 702 is parsed when it reaches a maximum length of twenty-four hours. For example, service window 702 can be approached in scanline order according to time and parsed when it reaches twenty-four hours in length. In such instance, service window 702 can be parsed after hour 31 (i.e. parsed at time 32:00) and result in daytime intervals 704 and 706. Importantly, even though daytime interval 704 actually extends into Saturday during hours 24-31 (i.e. times 24:00-32:00), daytime interval 704 can be associated with Friday because it begins on Friday.

In other implementations, the parsing of service window 702 can be based on other parameters rather than parsing when a maximum length is reached. For example, service window 702 can be parsed when it begins extending into Saturday. Thus, service window 702 can be parsed after hour 23 (i.e. at time 24:00) so that daytime intervals 708 and 710 are generated.

As another example, service windows that span multiple days can be parsed at specific designated times, such as after hour 27 (at time 28:00). Thus, service window 702 can be parsed after hour 27 to generate daytime intervals 712 and 714. In such fashion, a human perception of “late night” (e.g. 3:45 AM) versus “early morning” (4:15 AM) can be incorporated.

Returning to FIG. 2, at (212) a desired subset of weekdays and/or a desired subset of hours can optionally be obtained. In particular, a guidebook summary can be computed at (214) and the desired subset of weekdays and/or a desired subset of hours obtained at (212) can influence such computation. For example, the desired subset of weekdays can include Saturday and Sunday, such that the guidebook summary computed at (214) provides a summary of the guidebook result only with respect to the weekend.

As another example, the desired subset of hours can be business hours, such that the guidebook summary computed at (214) provides a summary of the guidebook result only with respect to business hours. The desired subset of weekdays and/or a desired subset of hours can saved in memory and accessed at (212) or can be an aspect of a user-inputted request received or analyzed at (212). The desired subset of weekdays and/or a desired subset of hours will be discussed further with respect to step (214).

At (214) a guidebook summary is computed. In particular, the guidebook summary computed at (214) can summarize a time interval and a set of days of the week over which one or more transit routes recommended by a guidebook result provide typically good service from the origin to the destination. The guidebook summary can be computed at (214) in such a way that the guidebook summary maximizes a probability that the summary covers a randomly selected time on a randomly selected day of the week.

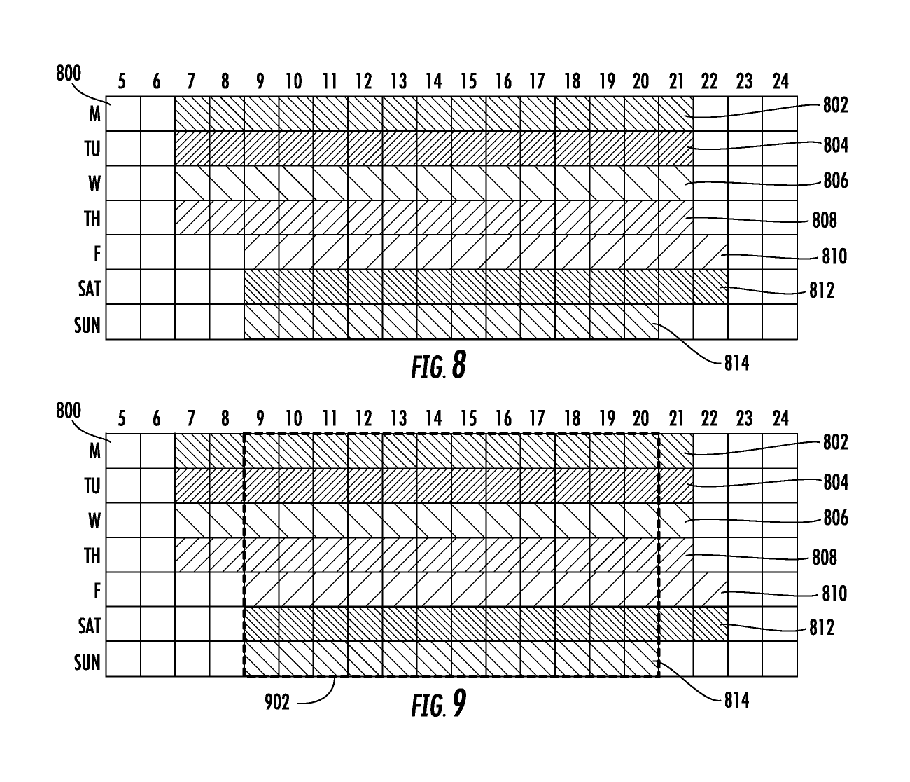

For example, FIG. 8 depicts a plurality of daytime intervals 802-814 according to an exemplary embodiment of the present disclosure. In particular, daytime intervals 802-814 represent intervals of time associated with particular days of the week over which available transit trips along one or more transit routes recommended by the guidebook result are of typically high quality. For example, daytime interval 802 is associated with Monday and runs from 7:00-22:00.

As shown in FIG. 8, daytime intervals 802-814 can be depicted or described by a graph 800. In particular, graph 800 has one unit for each day of the week on a y-axis and units of time on an x-axis. As discussed above, while daytime intervals 802-814 are shown as having been discretized into units one hour in length, such depiction is for the purposes of explanation only. For example, daytime intervals 802-814 can include intervals of time described in units of minutes or less (e.g. Tuesday, [8:38-16:19]).

The guidebook summary can be computed at (214) by analyzing the plurality of daytime intervals. As an example, the guidebook summary can be determined by computing, for each instance in which portions of two or more of daytime intervals 802-814 share overlapping times independent of their associated days of the week, a total number of hours included in such portions.

For example, daytime intervals 802, 804, 806, and 808 overlap for the time interval [7:00-22:00] independent of their days of the week. Such overlapping portions of daytime intervals 802, 804, 806, and 808 include a total of 60 hours. As another example, portions of daytime intervals 802, 804, 806, 808, 810, 812, and 814 overlap for the time interval [9:00-21:00]. Such overlapping portions of daytime intervals 802, 804, 806, 808, 810, 812, and 814 include a total of 84 hours. As yet another example, portions of daytime intervals 802, 804, 806, 808, 810, and 812 overlap for the time interval [9:00-22:00]. Such overlapping portions of daytime intervals 802, 804, 806, 808, 810, and 812 include a total of 78 hours.

It is not required that the overlapping portions of daytime intervals be associated with consecutive days. For example, a total number of hours included in overlapping portions of daytime intervals associated with a Monday, a Wednesday, and a Friday can be computed.

According to an aspect of the present disclosure, the overlapping portions that include the largest total number of hours can be selected as the guidebook summary. Therefore, with respect to FIG. 8, the portions of daytime intervals 802, 804, 806, 808, 810, 812, and 814 that overlap during the time interval [9:00-21:00] can be selected as the guidebook summary at (214). Thus, the guidebook summary would include Monday-Sunday, [9:00-21:00].

As another example, the guidebook summary can be determined at (214) by computing, for each of a plurality of x-axis intervals in which portions of two or more daytime intervals continuously overlap with respect to the x-axis, a total area covered by such portions over such x-axis interval. For example, portions of daytime intervals 802, 804, 806, 808, 810, 812, and 814 continuously overlap for the x-axis interval [9:00-21:00]. Such overlapping portions of daytime intervals 802, 804, 806, 808, 810, 812, and 814 cover a total area of 84 square units.

According to an aspect of the present disclosure, the overlapping portions associated with the largest total area can be selected as the guidebook summary. Therefore, with respect to FIG. 8, the portions of daytime intervals 802, 804, 806, 808, 810, 812, and 814 that overlap during the x-axis interval [9:00-21:00] can be selected as the guidebook summary at (214) as 84 square units represents a maximum area covered by overlapping portions of the depicted daytime intervals.

As yet another example, the desired subset of weekdays and/or a desired subset of hours received at (212) can inform the computation of the guidebook summary at (214). For example, if the desired subset of weekdays includes only Monday through Friday, then the above described methods can be applied with respect to only daytime intervals 802-810. In such instance, the guidebook summary would be selected as Monday-Friday, [9:00-22:00].

Returning to FIG. 2, at (216) the guidebook summary computed at (214) is provided to a user. For example, the guidebook summary can be provided to a client device over a network and displayed visually or using a short text string.

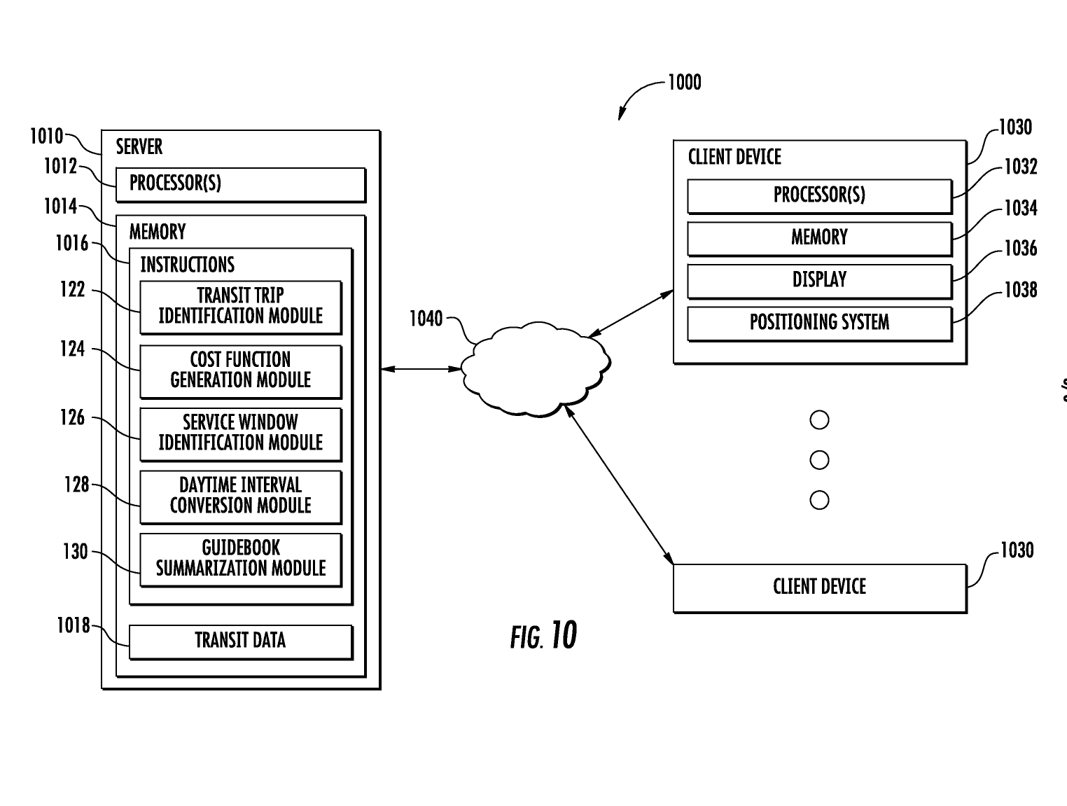

As an example, FIG. 9 depicts an exemplary guidebook summary 902 according to an exemplary embodiment of the present disclosure. Guidebook summary 902 is superimposed over graph 800 which depicts daytime intervals 802-814. Guidebook summary 902 can be provided to a user at (216) in the format depicted in FIG. 9.

Alternatively, guidebook summary 902 can be provided to the user at (216) as a short text string. Exemplary short text strings include, without limitation, “Monday-Sunday, [9:00-21:00]”; “M-Sun, 9 a-9 p”; and “Monday through Sunday between the hours of 9 AM and 9 PM”.

The guidebook summary can be provided to the user at (214) in association with one or more recommended transit routes, the next departure times of transit trips associated with the recommended transit routes, a frequency associated with the recommended transit routes, and/or any other suitable information.

While the above provided examples of a guidebook summary provide a single continuous time interval over a set of days of the week, other formats can be used to satisfy the present disclosure. In some implementations, multiple guidebook summaries can be computed, provided, and/or merged. Further, in the event that multiple sets of overlapping portions of daytime intervals include equal numbers of hours or cover an equal amount of total area, the multiple sets can be jointly recommended or can be selected from based upon one or more pre-set or user-specific criteria.

FIG. 10 depicts an exemplary computing system 1000 that can be used to implement the methods and systems for transit routing planning according to aspects of the present disclosure. The system 1000 is a client-server architecture that includes a server 1010 that communicates with one or more client devices 1030 over a network 1040. The system 1000 can be implemented using other suitable architectures, such as a single computing device.

The system 1000 includes a server 1010, such as a web server. The server can be implemented using any suitable computing device(s). The server 1010 can have a processor(s) 1012 and a memory 1014. The server 1010 can also include a network interface used to communicate with one or more remote computing devices (e.g. client devices) 1030 over a network 1040.

The processor(s) 1012 can be any suitable processing device, such as a microprocessor, microcontroller, integrated circuit, or other suitable processing device. The memory 1014 can include any suitable computer-readable medium or media, including, but not limited to, non-transitory computer-readable media, RAM, ROM, hard drives, flash drives, or other memory devices. The memory 1014 can store information accessible by processor(s) 1012, including instructions 1016 that can be executed by processor(s) 1012. The instructions 1016 can be any set of instructions that when executed by the processor(s) 1012, cause the processor(s) 1012 to provide desired functionality. For instance, the instructions 1016 can be executed by the processor(s) 1012 to implement the transit trip identification module 122, the cost function generation module 124, the service window identification module 126, the daytime interval conversion module 128, and the guidebook summarization module 129.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media.

Memory 1014 can also include data 1018, such as transit data, that can be retrieved, manipulated, created, or stored by processor(s) 1012. The data 1018 can be stored in one or more databases. The one or more databases can be connected to the server 1010 by a high bandwidth LAN or WAN, or can also be connected to server 1010 through network 1040. The one or more databases can be split up so that they are located in multiple locales.

The server 1010 can exchange data with one or more client devices 1030 over the network 1040. Although two clients 1030 are illustrated in FIG. 10, any number of client devices 1030 can be connected to the server 1010 over the network 1040. The client devices 1030 can be any suitable type of computing device, such as a general purpose computer, special purpose computer, laptop, desktop, integrated circuit, mobile device, smartphone, tablet, or other suitable computing device.

Similar the computing device 1010, a client device 1030 can include a processor(s) 1032 and a memory 1034. The memory 1034 can store information accessible by processor(s) 1032, including instructions that can be executed by processor(s) and data. The client device 130 can include various input/output devices for providing and receiving information from a user, such as a touch screen, touch pad, data entry keys, speakers, and/or a microphone suitable for voice recognition. For instance, the computing device 1030 can have a display 1036 for presenting information, such as a guidebook summary.

The client device 1030 can also include a positioning system 1038 that can be used to identify the position of the client device 1030. The positioning system 1038 can be optionally used by the user to monitor the user's position relative to a transit route. The positioning system 1038 can be any device or circuitry for monitoring the position of the client device 1030. For example, the positioning device 1038 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

Importantly, in situations in which the systems and method discussed herein collect information about users, such as position data, user preferences, or other information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in or more ways before it is stored or used, so that personally identifiable information is removed.

The network 1040 can be any type of communications network, such as a local area network (e.g. intranet), wide area network (e.g. Internet), or some combination thereof. The network 1040 can also include a direct connection between a client device 1030 and the server 1010. In general, communication between the server 1010 and a client device 1030 can be carried via network interface using any type of wired and/or wireless connection, using a variety of communication protocols (e.g. TCP/IP, HTTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for summarizing available transit trips, the method comprising:
generating, based on a plurality of transit trips from an origin to a destination, a cost function specifying a trip cost as a function of time over a time period;
identifying a plurality of service windows comprising intervals of time over which the trip cost specified by the cost function satisfies a quality criterion;
translating the plurality of service windows into a plurality of daytime intervals, each daytime interval being associated with a day of the week and having a duration of twenty-four hours or less; and
identifying a guidebook summary that includes only portions of daytime intervals and maximizes a total number of hours included in such guidebook summary, the guidebook summary describing an interval of time and a set of days of the week.

2. The computer-implemented method of claim 1, further comprising providing the guidebook summary as a text string.

3. The computer-implemented method of claim 1, wherein the cost function is a piecewise linear function comprising a plurality of linear trip segments, each linear trip segment modeling the trip cost, including waiting time, of one of the plurality of transit trips as a function of time.

4. The computer-implemented method of claim 1, wherein:
generating a cost function specifying a trip cost as a function of time comprises generating a cost function specifying, for each point in time over the time period, an expected time until arrival at the destination based on available departures from the origin; and
identifying a plurality of service windows comprising intervals of time over which the trip cost specified by the cost function satisfies a quality criterion comprises identifying a plurality of service windows comprising time intervals over which the expected time specified by the cost function is less than or equal to a threshold value.

5. The computer-implemented method of claim 1, wherein identifying a plurality of service windows comprising time intervals over which the trip cost specified by the cost function satisfies a quality criterion comprises:
identifying a plurality of local maximums exhibited by the cost function over the time period; and
identifying a plurality of service windows comprising time intervals over which the trip cost specified by the cost function is less than a median value of the plurality of local maximums.

6. The computer-implemented method of claim 1, wherein identifying a plurality of service windows comprising time intervals over which the trip cost specified by the cost function satisfies a quality criterion comprises:
determining a global minimum value expressed by the cost function; and
identifying a plurality of service windows comprising time intervals over which the trip cost specified by the cost function is less than or equal to a threshold value, the threshold value having been determined based on the global minimum value.

7. The computer-implemented method of claim 1, wherein each of the plurality of service windows is constrained to begin at a local minimum of the cost function.

8. The computer-implemented method of claim 1, wherein translating the plurality of service windows into a plurality of daytime intervals comprises, for each of the plurality of service windows:
determining whether the service window is greater than twenty-four hours in length;
parsing the service window into two or more service windows when the service window is greater than twenty-four hours in length; and
associating the service window with the day of the week upon which such service window begins.

9. The computer-implemented method of claim 1, wherein identifying the guidebook summary comprises:
computing, for each instance in which portions of two or more of the plurality of daytime intervals share overlapping times independent of their associated days of the week, a total number of hours included in such portions; and
selecting the overlapping portions of the plurality of daytime intervals that include the largest total number of hours as the guidebook summary.

10. The computer-implemented method of claim 1, wherein identifying the guidebook summary comprises:
traversing a graph describing the plurality of daytime intervals, the graph having each day of the week as a unit on a y-axis and units of time on an x-axis;
computing, for each of a plurality of x-axis intervals in which portions of two or more daytime intervals continuously overlap with respect to the x-axis, a total area covered by such portions over such x-axis interval; and
selecting as the guidebook summary the x-axis interval associated with the largest total area and the days of the week associated with the portions of the two or more daytime intervals that continuously overlap over the x-axis interval associated with the largest total area.

11. A computer-program product comprising a non-transitory computer-readable storage medium storing computer-readable instructions for summarizing available transit trips from an origin to a destination, the instructions when executed by a processor, cause the processor to perform operations, the operations comprising:
identifying a plurality of service windows comprising intervals of time over which the available transit trips satisfy a quality criterion; and
selecting as a guidebook summary a set of days of the week and a continuous interval of time which include only portions of service windows, such that a total number of hours included in the guidebook summary is maximized.

12. The computer-program product of claim 11, wherein identifying a plurality of service windows comprising intervals of time over which the available transit trips satisfy a quality criterion comprises:
generating a cost function describing, based on the available transit trips from the origin to the destination, a total time to arrival at the destination for each point in time over a time period; and
identifying a plurality of service windows comprising maximal time intervals over which the total time to arrival described by the cost function remains at or below a threshold value.

13. The computer-program product of claim 11, storing further instructions for performing further operations comprising, prior to selecting the guidebook summary:
parsing any service window exceeding twenty-four hours in length into two or more service windows; and
associating each of the plurality of service windows with the day of the week in which such service window begins.

14. The computer-program product of claim 13, wherein selecting as a guidebook summary a set of days of the week and a continuous interval of time which include only portions of service windows, such that a total number of hours included in the guidebook summary is maximized comprises:
identifying a plurality of sets of overlapping portions of two or more service windows, each set of overlapping portions having an overlapping interval of time irrespective of the days of the week associated with the overlapping portions of such set;
computing, for each set of overlapping portions, a total number of hours included in such set by multiplying the overlapping interval of time associated with such set by the number of overlapping portions included in such set; and
selecting as the guidebook summary the set of overlapping portions that includes the largest total number of hours.

15. The computer-program product of claim 13, wherein selecting as a guidebook summary a set of days of the week and a continuous interval of time which include only portions of service windows, such that a total number of hours included in the guidebook summary is maximized comprises:
mapping the plurality of service windows on a graph having one unit on a first axis for each day of the week and units of time on a second axis;
computing, for each set of portions of two or more service windows that overlap with respect to the second axis, a total area covered by such set of portions; and
selecting as the guidebook summary the set of portions that covers the largest total area.

16. The computer-program product of claim 11, storing further instructions for performing further operations comprising, prior to selecting the guidebook summary, receiving a desired set of days of the week, wherein the set of days of the week selected as the guidebook summary is a subset of the desired set of days of the week.

17. A computing system for transit trip summarization, the computing system comprising a processor and a memory, the system comprising:
a cost function generation module implemented by the processor, the cost function generation module configured to generate a cost function specifying a trip cost as a function of time over a time period based on a plurality of transit trips from an origin to a destination;
a service window identification module implemented by the processor, the service window identification module configured to identify a plurality of service windows comprising intervals of time over which the trip cost specified by the cost function satisfies a quality criterion;
a daytime interval conversion module implemented by the processor, the daytime interval module configured to convert the plurality of service windows into a plurality of daytime intervals, each of the plurality of daytime intervals being associated with the day of the week on which such daytime interval begins and having a duration twenty-four hours or less in length; and
a guidebook summarization module implemented by the processor, the guidebook summarization module configured to select as a guidebook summary a set of days of the week and a continuous interval of time, the guidebook summary including only portions of daytime intervals and maximizing a probability that the guidebook summary includes a randomly selected time on a randomly selected day of the week.

18. The computing system of claim 17, wherein:
the cost function comprises a piecewise linear function comprising a plurality of linear trip segments, each linear trip segment modeling the cost, including waiting time, of one of the plurality of transit trips as a function of time; and
the quality criterion comprises a threshold cost such that the trip cost specified by the cost function satisfies the quality criterion when it is less than or equal to the threshold cost.

19. The computing system of claim 17, wherein the daytime interval conversion module is configured to convert the plurality of service windows into a plurality of daytime intervals by performing operations comprising:
parsing any service window exceeding twenty-four hours in length into two or more service windows; and
associating each of the plurality of service windows with the day of the week in which such service window begins, such that the plurality of daytime intervals are formed.

20. The computing system of claim 17, wherein the guidebook summarization module is configured to select as a guidebook summary a set of days of the week and a continuous interval of time by performing operations comprising:
traversing the plurality of daytime intervals in a scanline ordering according to the time at which each of the plurality daytime intervals begins;
computing, for each overlapping subset of daytime intervals, a total time encompassed by such overlapping subset of daytime intervals; and
selecting as the guidebook summary the subset of daytime intervals that encompasses the largest total time.
